(19) United States
(12) Patent Application Publication
(10) Pub. No.: US 2006/0065115 A1
(43) Pub. Date: Mar. 30, 2006

(54) FIBERGLASS LAMINATION BOOM ASSEMBLY

(76) Inventor: Jimmy D. ASHLEY, Edenton, NC (US)

Correspondence Address: MILLS LAW FIRM, PLLC, P.O BOX 1245, Cary, NC, 27512-1245, US

(21) Appl. No.: 11/161,367

(22) Filed: Aug. 1, 2005

Related U.S. Application Data
(60) Provisional application No. 60/522,408, filed on Sep. 27, 2004.

(51) Int. Cl. F15B 11/00

(52) U.S. Cl. 91/508

(57) ABSTRACT

A overhead boom apparatus for a fiberglass lamination process includes articulated inner and outer boom members having curved conduits at the ends providing guided paths therethrough for the routing of the supply lines from supply sources to an applicator.

### RELATED APPLICATION

This application claims the benefit of U.S. Provisional Application No. 60/522,408 filed on Sep. 27, 2004, in the name of Jimmy D. Ashley and entitled “Fiberglass Lamination Boom Assembly”.

### FIELD OF THE INVENTION

The present invention relates to apparatus for applying fiberglass lamination and, in particular, to a boom assembly for protectively routing supply lines for fiberglass lamination.

### BACKGROUND OF THE INVENTION

Typical fiberglass lamination processes include mobile gun carts for locating supplies adjacent a work station. After the application is undertaken, the cart must be moved to differing locations requiring stopping application and exposing the supply lines to damage and wear. Greater flexibility has been provided by prior overhead boom assemblies that include an inner pivoting arm that pivots a half revolution relative to a mounting wall and a outer arm pivoted to the inner arm that pivots almost a complete revolution. In such assemblies, the supply lines from the resin and catalyst sources were routed along the bottom of the inner boom arms and mechanically tied at spaced locations. The supply line was axially routed through the interior of the cylindrical outer boom arm. In operation, the supply line was subject to damage resulting in line breakage and resultant chemical spills in the work area. Further, the line routing from the inner boom arm to the axial inlet on the outer boom arm was found prone to kinking and twisting, also increasing line wear rate requiring replacement. Moreover, the lines exited the outer end axially with the lines downwardly depending to the applicator. In effecting boom movement about the work station, the force on the line against the opening caused the line to kink or collapse, interrupting resin flow and leading also to rupture and/or premature wear.

### SUMMARY OF THE INVENTION

The present invention provides an overhead boom assembly for routing of the supply lines to applicator in protected guide paths along the articulated boom arms that eliminates line kinking allowing the operator to transit a wide sectored area to access the molds as necessary without process interruption. The inner arm includes curved entry conduits that permits connection with the supply lines without bending. The line is routed from the entry conduit along the inner arm to a curved exit conduit that provides a gradual transition path to the outer boom arm. The outer boom arm includes a curved entry conduit that provides at transition curvature for the line allowing full articulation without line collapse. The line is routed internally through the outer boom arm to a downwardly curved elbow leading to the applicator and supporting the line against collapse during applicator movement about the work area. To facilitate insertion through the inner boom arm an enlarged opening is provided whereby the line can be accessed for feeding through the exit conduit. The line may be directly routed through the outer boom arm.

Accordingly, it is an object of the present invention to provide a lamination boom assembly providing a guided path for supply lines that avoid kinking and line wear.

Another object of the invention is to provide a fiberglass lamination boom assembly wherein the supply lines are routed through protective internal paths and stress free exterior paths to limit line damage and process interruption.

A further object of the invention is to provide a fiberglass lamination boom assembly that facilitates convenient internal routing and replacement of supply lines.

### DESCRIPTION OF THE DRAWINGS

The above and other features and advantages of the present invention will become apparent upon reading the following description taken in conjunction with the accompanying drawing in which:

FIG. 1 is a side elevational view of a fiberglass lamination boom assembly in accordance with an embodiment of the invention;

FIG. 2 in an enlarged fragmented side elevation view of Details A, B and C of the boom assembly shown in FIG. 1;

FIG. 3 is an enlarged cross sectional view of the base assembly of the boom support assembly;

FIG. 4 is an enlarged cross sectional view of the routing conduit for the fluid lines of the boom support assembly;

FIG. 5 is an enlarged side elevational view of the knuckle assembly between the inner boom and the outer boom; and

FIGS. 6 and 7 are schematic plan views of the boom assembly illustrating range of movement.

### DETAILED DESCRIPTION OF THE PREFERRED EMBODIMENT

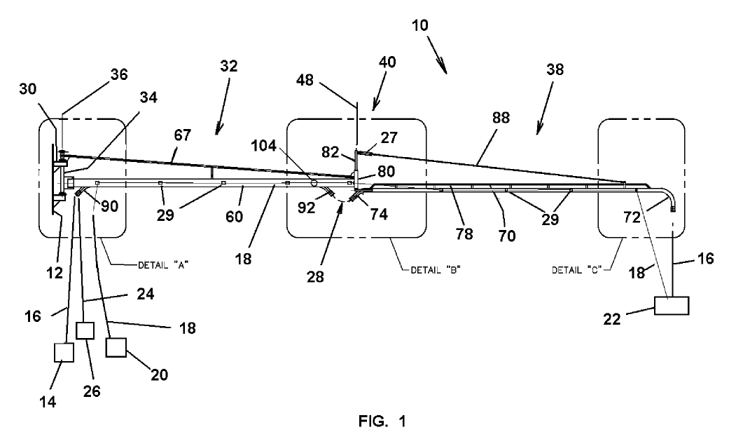

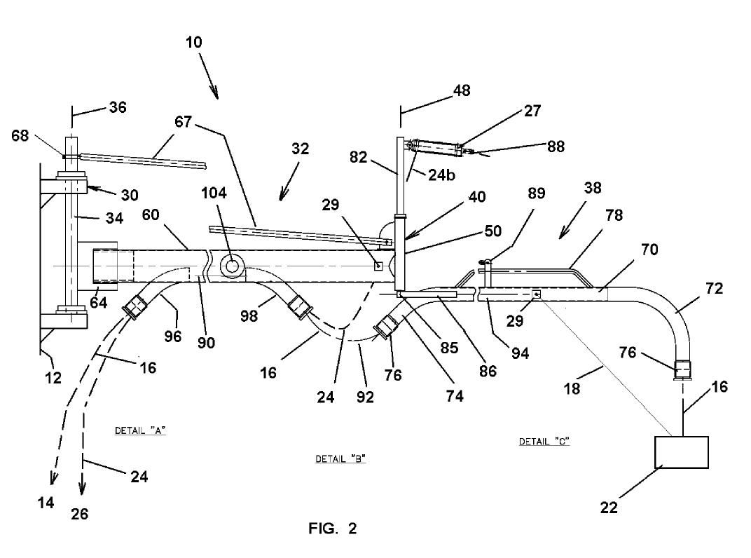

Referring to FIGS. 1 and 2, there is shown a fiberglass boom assembly 10 mounted at an elevated position on a vertical support wall 12 for the routing of resin from bulk resin sources 14 in lines 16, and fiberglass strands 18 from a source 20, to a conventional chopped fiberglass applicator 22. Air is routed in air line 24 from pressure source 26 to a fluid actuator 27 for varying the inclination of the outer boom as described in greater detail below. Additional lines may be provided for other fluids, such as catalysts. The boom assembly 10 includes an internal routing path 28 for preventing damage to the lines during operation. The routing path 28 has an inlet at the proximate inner end and an outlet at the distal outer end of the boom assembly. A plurality of axially spaced annular porcelain guides 29 are provided on the exterior of the inner boom and the outer boom for feeding the glass strand 18 to the applicator 20.

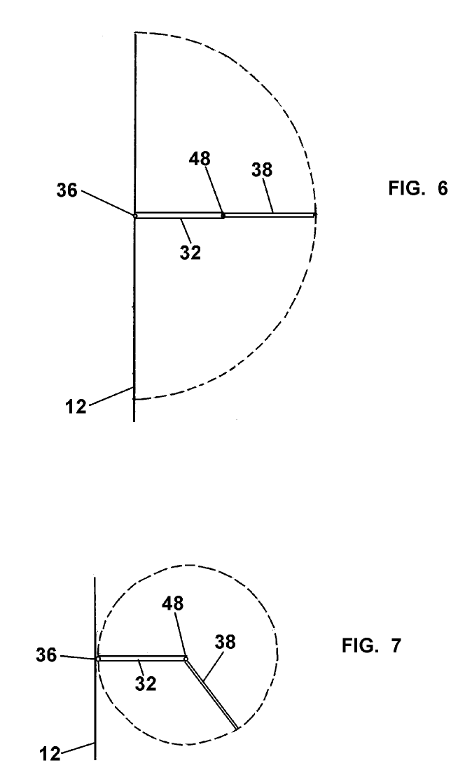

The boom assembly 10 comprises a base assembly 30 affixed to the wall 12, an inner boom 32 pivotally connected at shaft 34 to the base assembly 30 for rotation about a vertical axis 36, and an outer boom 38 pivotally connected at knuckle assembly 40 to the outer end of the inner boom assembly 32 for rotation about a vertical axis 48 and a horizontal axis 50. Referring to FIG. 7, the inner boom assembly 32 rotates 180° about the axis 36 from wall to wall. The outer boom assembly 38 rotates substantially 360° about the axis 48 whereby selective articulation will locate the inner end and thus the fiberglass applicator anywhere within the arc of the FIG. 6.

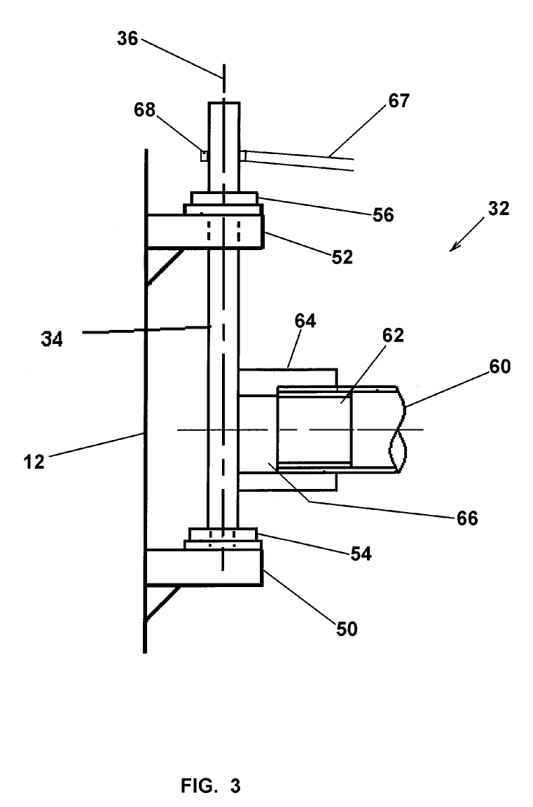

Referring to FIG. 3, the base assembly 30 includes vertically spaced base plates 50, 52 suitably affixed to the wall 12. The upper plate 50 includes a vertically aperture for receiving the shaft 34. The lower end of the shaft 34 is journaled at a bearing assembly 54 fixed to the top surface of the lower plate 50. The upper portion of the shaft 34 is journaled at a bearing assembly 56 fixed to the top surface of the upper plate 52.

The inner boom 32 includes an elongated cylindrical tubular inner arm 60. The inner end of the inner arm 60 includes a telescopically inserted reinforcing sleeve 62. The inner arm 60 is attached to the shaft 34 at a support plate 64. The inner vertical end of the support plate 64 is welded to the center portion shaft 34 between the bearing assemblies 50, 52. The support plate 64 includes a semicircular center section 66 for receiving the inner end of the arm 60 and attaching thereto by suitable fastening, preferably welding. A diagonal reinforcing bar 67 is connected to the upper end of the shaft 34 at connector 68 and to the knuckle assembly 40 for supporting the cantilevered weight of the boom assembly.

The outer boom 38 includes a center tubular section 70 having a 90° tubular elbow 72 at an outer end and a 45° tubular elbow 74 at an inner end. The elbows 72, 74 terminate with conduit chase nipples 76. A truss 78 is attached at the top of section 70 for providing reinforcing to the cantilevered outer boom 38.

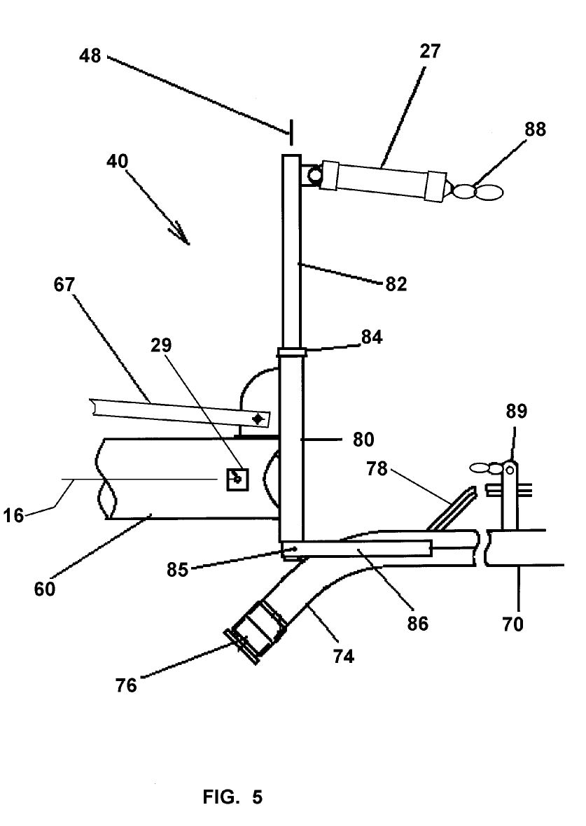

Referring to FIG. 5, the knuckle assembly 40 pivotally interconnects the inner boom 32 and the outer boom 38 for rotation about the axis 48. The knuckle assembly 40 includes a cylindrical support sleeve 80 vertically attached to the outer end of the inner boom 32 and rotatably supporting a pivot shaft 82 at the upper end at bearing assembly 84. The lower end of the pivot shaft 82 projects downwardly below the sleeve 80 and is pivotally connected at pin connection 85 to the inner end of a pivot arm 86 connected at the side of the outer boom 38 and providing vertical inclination of the outer boom 38 about the horizontal axis. For effecting inclination of the outer boom 38, the actuator 27 is connected at the upper end of the shaft 82 and has an output piston connected to a chain 88. The chain 88 is connected at an outer end to a bracket 90 at the outer end of the outer boom 38.

The foregoing assembly provides for 180° pivoting of the inner boom 32 about vertical axis 36 coupled with cojoint 360° pivoting of the outer boom 38 about axis 48 for discrete omnibus location of the applicator within the swept area. Moreover, the actuator 27 allows selective downward pivoting of the outer boom assembly 38 about the horizontal axis 85. During such movement, the lines remain overhead and with the above-described routing path remain free from twisting, kinking or other potentially damaging conditions.

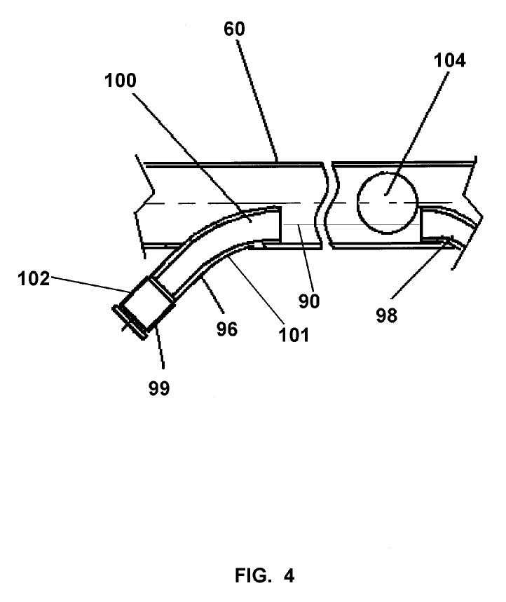

Referring to FIG. 2, the routing path 27 provides a gradual stress free path for the lines from their respective sources and includes an interior entry section 90 through the inner boom assembly 32, an exit section 94 through the outer boom assembly 38 and a transition section 92 therebetween. The entry section 90 includes an inlet elbow 96 and an outlet elbow 98 in the inner boom arm 60. The exit section 94 includes the inlet elbow 74 and the outlet elbow 72 on the outer boom arm 70. The elbows terminate with chase nipples 99 and lie in a vertical plane. As shown in FIG. 4, the elbows 96, 98 are inserted through apertures the inner boom. The elbows 96, 98 are tubular and have straight inner ends 100, a curved center section 101, and a downwardly and outwardly extending straight outer end 102. The inner ends 100 are inserted through apertures in the base of the inner boom arm 60, extend axially therethrough and are attached by suitable means such as welding. The inner elbow 96 is located adjacent the base assembly 30 and directed toward the resin source, which may be kept in bulk supply compactly along the wall 12. The outer elbow 98 is located slightly inward from the outer end of the arm 60 to provide a curved registering arcuate path with the elbow 72. The elbows are curved, preferably about 45° providing stress free support for the lines in assembly. An enlarged access opening 104 is formed in the arm 60 slightly in advance of the outlet elbow 98. At the inner boom, the resin lines 16 and the air line 24 are guided from the sources through the inlet elbow 96, along the arm cavity to the access opening 104. At the opening, the ends of the line are manually grasped and inserted through the outlet elbow 98 thereby facilitating installation, repair and maintenance of the lines. In assembly, the elbows provide gradual curvatures for the lines, avoiding kinking, twisting and other damage during relative movement of the boom assemblies. From the outlet elbow 98, the air line 24 is routed with gradual curvature upwardly to the actuator 27. The resin line 16 is routed in the transition section 92 in a gradually curved path sufficient to avoid twisting and kinking of the line through the range of articulation at the knuckle assembly 40. In the exit section 94, the line is gradually curved through the inlet elbow 74, through the continuous passage in the outer boom 70, and outwardly and downwardly through outlet elbow 72 for connection to the applicator 22.

It will thus be appreciated that the supply lines traverse protected internal guide paths with curvature protecting against damage during operation and with exterior guide paths avoid undue stress during boom articulation.

Having thus described a presently preferred embodiment of the present invention, it will now be appreciated that the objects of the invention have been fully achieved, and it will be understood by those skilled in the art that many changes in construction and widely differing embodiments and applications of the invention will suggest themselves without departing from the sprit and scope of the present invention. The disclosures and description herein are intended to be illustrative and are not in any sense limiting of the invention, which is defined solely in accordance with the following claim.

What is claimed is:

1. An assembly for fiberglass lamination assembly for routing supply lines to an applicator, comprising: a tubular inner boom member connected at an inner end to a vertical support member for pivotal movement about a first vertical axis; a tubular outer boom member connected to the outer end of said inner boom member for pivotal movement about a second vertical axis and a horizontal axis; actuator means operative between said boom members for pivoting said outer boom member about said horizontal axis; curved tubular inner boom elbows at said ends of said inner boom member, said inner boom elbows having outer ends diverging outwardly and downwardly with inner ends extending axially in said inner boom member; an access opening in said inner boom member adjacent the outer inner boom elbow, said inner boom elbows establishing therebetween a path for routing fluid lines for a lamination process and said access opening facilitating alignment of said fluid lines with outer inner boom elbow; a curved outer boom elbow at the inner end of said outer boom member having an outer end diverging outwardly and downward and an axially extending inner end, said outer boom member terminating with a downwardly curved outer end and defining with said outer boom elbow a path for routing the fluid lines from said inner boom member through said outer boom member to the applicator for conducting the lamination process.

2. The assembly as recited in claim 1 wherein said outer ends of said elbows are inclined about 45° with respect to the associated boom member.

3. The assembly as recited in claim 1 wherein said outer end of said outer boom member is inclined about 90° with respect to said outer boom member.

4. An assembly for fiberglass lamination assembly for routing supply lines to an applicator, comprising: a base member; a tubular inner boom arm pivotally connected to an inner end of said inner boom arm for rotation about a first vertical axis; a tubular outer boom member; a pivot assembly interconnecting an inner end of said outer boom arm with an outer end of said inner boom arm for rotation about a second vertical axis; downwardly opening apertures formed in inner boom arm adjacent said inner and outer ends thereof; curved tubular inner boom elbows inserted through said apertures in said inner boom arms, said inner boom elbows having outer ends diverging outwardly and downwardly at an inclination of about 45°, said inner boom elbows having inner ends extending axially in said inner boom arm; an enlarged access opening in a side of said inner boom member adjacent the outer inner boom elbow, said inner boom elbows establishing therebetween a path for routing fluid lines for a lamination process and said access opening facilitating alignment of said fluid lines with outer inner boom elbow; a curved outer boom elbow at the inner end of said outer boom arm having an outer end diverging outwardly and downwardly toward said outer inner boom elbow at an inclination of about 45° and an axially extending inner end, said outer boom arm terminating with a downwardly curved outer end inclined about 90° with respect thereto, said curved outer end defining with said outer boom elbow a path for routing the fluid lines from said inner boom arm through said outer boom arm to applicator means to the applicator.

5. A fiberglass lamination boom assembly, comprising: a tubular inner boom member connected to a vertical support member for pivotal movement about a first vertical axis; a tubular outer boom member connected to the outer end of the inner boom member for pivotal movement about a second vertical axis; curved tubular inner boom elbows at the ends of said inner boom member having outer ends diverging outwardly and downwardly and inner ends extending axially in said inner boom member; an access opening in said inner boom member adjacent the outer inlet boom elbow, said inner boom elbows establishing therebetween a path for routing fluid lines for a lamination process and said access opening facilitating alignment of said fluid lines with outer inner boom elbow; a curved outer boom elbow at the inner end of said outer boom member having an outer end diverging outwardly and downward and an axially extending inner end, said outer boom member terminating with a downwardly curved outer end and defining with said outer boom elbow a path for routing the fluid lines from said inner boom member through said outer boom member to the applicator means.
